(19) United States
(12) Patent Application Publication
(10) Pub. No.: US 2005/0040927 A1
(43) Pub. Date: Feb. 24, 2005

(54) Method of avoiding arc prolongation on current interruption, paticulary a fuse

(76) Inventor: Tadashi Umeda, Hitachinaka City (JP)

Correspondence Address: Tadashi Umeda, 2-11-3 Matsudo-cho, Hitachinaka City, 3/2-0016, JP

(21) Appl. No.: 10/603,854

(22) Filed: Jun. 26, 2003

(30) Foreign Application Priority Data
Jul. 1, 2002 (JP) 2002-226726

(51) Int. Cl. H01H 85/38

(52) U.S. Cl. 337/273

(57) ABSTRACT

The shock wave generated by an explosive arc discharge in the fuse body interrupts effectively a prolongation of arcing by means of converging and reflecting the shock wave onto arc itself. Preparing the concave wall inside of the fuselink body attained this.

Arc heating results not only internal ignition of fuse body, but also the external flashover between the fuse holders and finally the equipment where the fuselink is installed. The damage may result enormous.

### THE SUMMARY OF THE INVENTION

This invention solves the requirements for the following cases:

In the case that the voltage between the terminals of fuse is high enough, in the case that the entering current is also high compared to the rating, in the case that the fuse length becomes shorter than before, following the miniaturization of electric and electronic components, or in the case that source is high current DC.

For these cases any conventional fuse withal filler material does not work reliably. For this reason this invention relates an enhancing the breaking capacity of the fuse by making an arc breaking more surely.

A particular object of the invention is to take advantage of the shock wave generated by a sudden evaporation of the fuse element by means of reflecting and converging it at the internal concave wall or polyhedral inside concave wall of the fuse body of the fuse's enclosure and also having the shock wave converge on the arc itself, so as to boost the atmospheric pressure around the arc, which leads to extinguish the arc.

### DETAILED DESCRIPTION OF THE INVENTION

The individual steps of arc breaking are analytically mentioned in due course.

1) In the first place, general sequence of the arc behavior is as follows when over current entered into a fuselink. (FIG. 1) (Reference 1)

At first the current rises at the period “a”, when the over current enters.

In this period “a” the fuse voltage between the both terminals is still low because element is not melted yet and the voltage slightly rises corresponding to the rise of the current.

At the end of this period a fuselink voltage suddenly jumps up after element melt down.

This voltage jump-up is confirmed between the both terminals and voltage rise is caused by the conductance of the circuit.

Usually arc discharge starts at the very end of period “a”, while up to this point only 40% of the total element is vaporized. (Ref. 1)

When the arcing continues beyond this point and becomes persistent enough until ¼ cycle of AC where AC voltage cross zero shown in FIG. 1, the fuselink is mostly damaged.

Therefore it is strongly requested that arc discharge may be terminated as soon as possible after period “a” of FIG. 1.

2) In the next place; present invention proceeds further as follows:

The arc discharge which overrun the end of period “a” causes a sudden evaporation of the Element at the middle of it, because after “a” the current goes stronger and voltage goes higher, then the generated arc heat is consequently high enough to melt the remainder of the element explosively.

This sudden gas expansion generates the shock wave. (Ref 2)

3) This shock wave goes forward in the fuse body and reflects nearly optically at inner wall of fuse body.

This inner wall is so prepared as to form concave mirror,—this is the core of the invention—then the shock wave converges at the focus of the concave mirror. FIG. 2 (Ref.3)

The wall shown in FIG. 2 has the paraboloidal concave, and other concave which forms the focus as the spheroidal concave or a hyperboloidal concave is also applicable for this purpose, corresponding to the characteristics of the fuselink's configuration.

It is reported that strictly speaking diverging the shock wave is not ruled by the optical focusing but by the aerodynamic focusing which shifts the focus point closer to the reflection wall (Ref.3)

It however confirmed the optical focus may practically substitute for the aerodynamic one.

4) Around the point or the axis where shockwave focused on, the shock wave's diameter is infinitely condensed to zero, while the shock wave's energy is mostly maintained.

Then the shock wave's energy density extraordinarily increases. And as the result the medium's transferring speed, medium's pressure and medium's temperature are elevated keenly.

Especially increase ratio of medium's pressure at the focus area reaches to 2.3˜3 times of the original pressure independently of Mach number of entered shock wave. (Ref.3) FIG. 3

5) As to the necessary factors for arc-extinction, the atmospheric pressure is as important as the cooling of the arc. This local increase of the pressure acts as the arc-extinction.

References

1: A. Wright & P. G. Newbery (1984) Electric Fuses, IEE, Power Engineering Series 2, p.38
2:Kazuki Takayama (1998) Shock wave, published by OHMSHA, p.72
3:Kazuki Takayama (1998) Shock wave Handbook, published by Spüringer Verlag Tokyo p.81˜96
4:Ionization phenomena in Gases (1969) Edited by Denki Gakkai, published by OHMSHA p. 199˜210

### BRIEF DESCRIPTION OF THE DRAWINGS

FIG. 1 is the explanatory drawing of the arc behavior at the point of current interruption when short circuit occurred. (Referred from reference 1)

FIG. 2 is the explanatory drawing, which shows the reflection and convergence of the shock wave at the concave wall. (Referred from reference 2)

FIG. 3 is the explanatory drawing, which shows the atmospheric pressure rises at the focused point of the shock wave. (Referred from reference 3)

FIG. 4 shows the first preferred embodiment of this invention by its cross section.

FIG. 5 shows explanatory drawing of mechanism of the invention.

FIG. 6 shows the firt preferred embodiment of this invention, which is especially applied for the small sized fuses.

FIG. 7 shows the second preferred embodiment of this invention.

FIG. 8 shows waveforms of the voltage and current during current interruption test of the second preferred embodiment of this invention.

FIG. 9 shows waveforms of the voltage and the current during current interruption test of conventional fuse. (for comparing to the fuse of the invention)

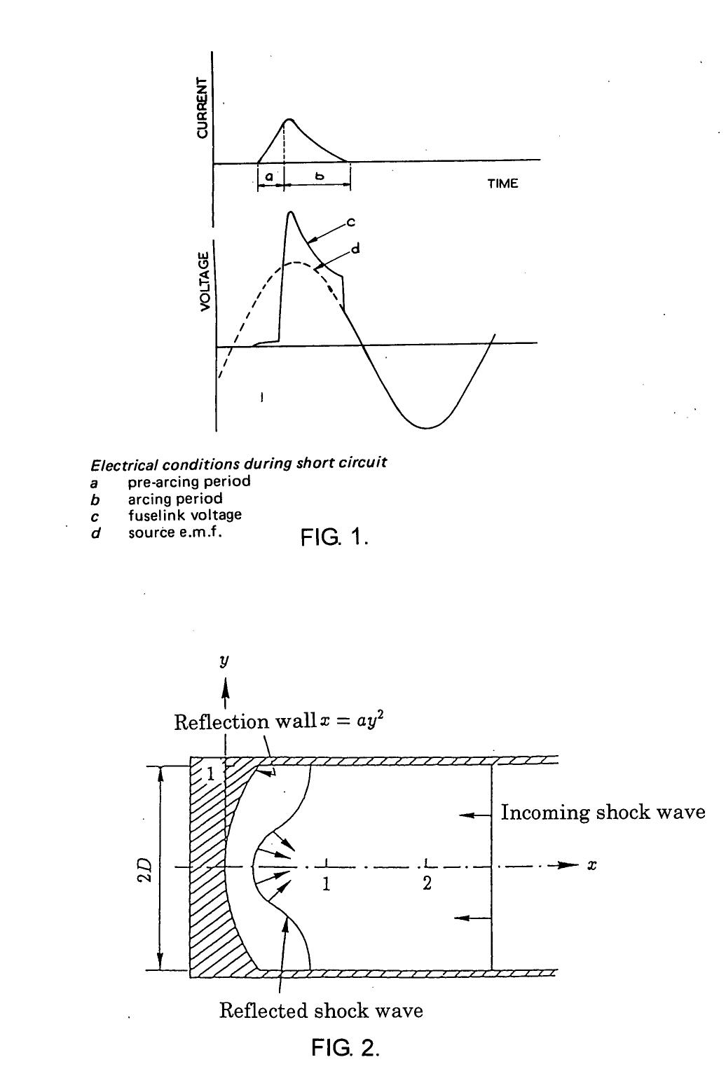

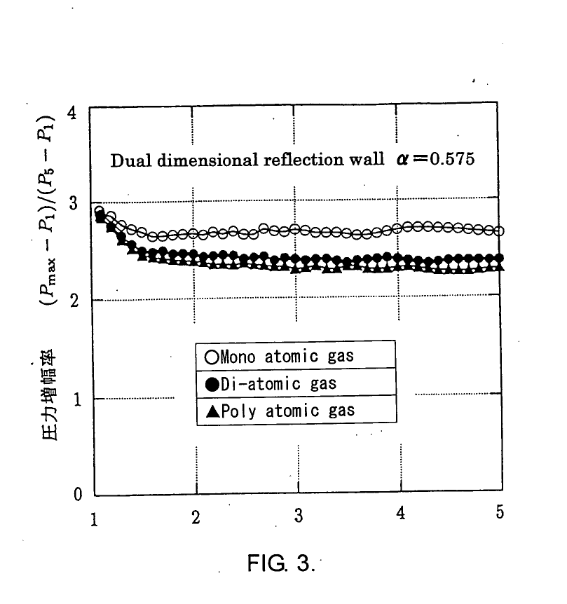

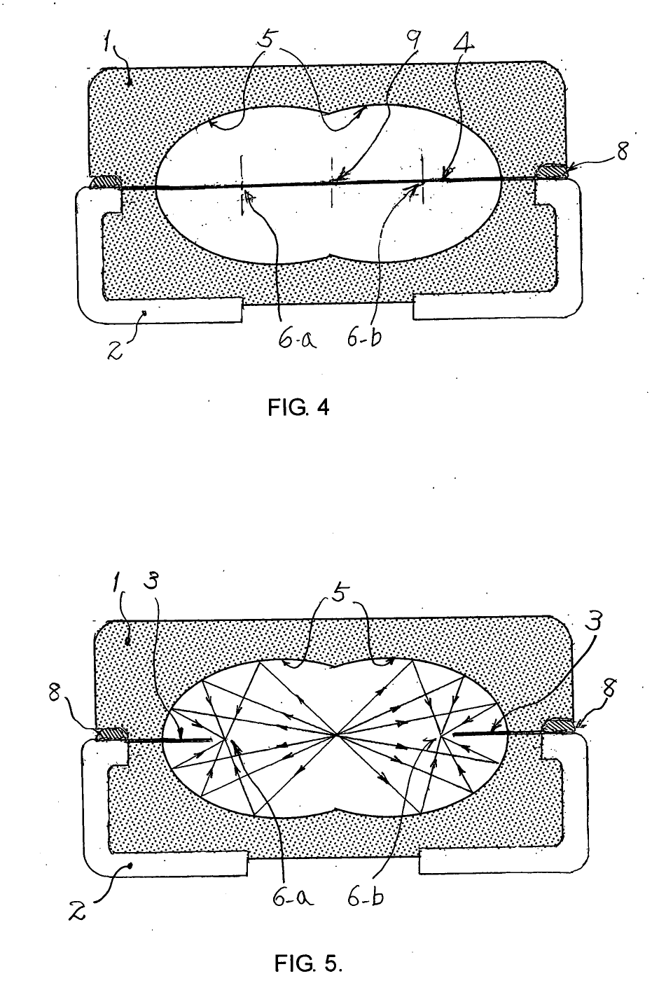

### REFERENCE NUMERALS

1 Electric insulator

2 Electric conductors

3 Fuse element (initial stage of arcing)

4 Fuse element

5 Concave walls for reflection

6-a, 6-b Convergent focus of the shock wave

7 Filled sand grain

8 Solder

9 Point of arc initiation

### DESCRIPTION OF THE FIRST PREFERRED EMBODIMENT

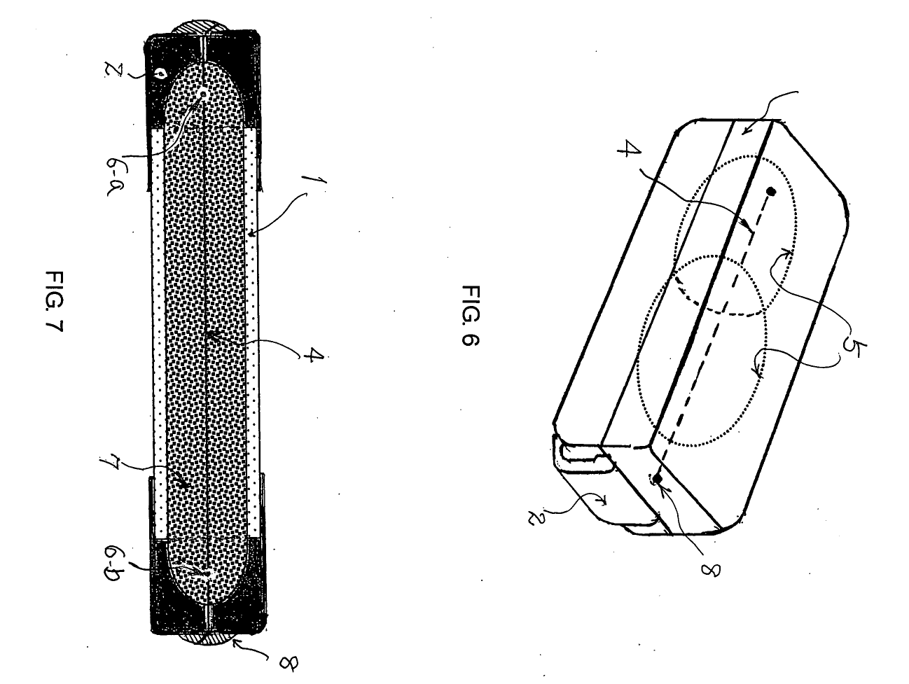

FIG. 5 and FIG. 6 shows a fuselink of which reflection wall for shock wave has two spheroidal concaves. Electrical insulation body consists of two spheroidal concaves which partially overlaps each other, i.e. two spheroidal concaves are so arranged individually as to one of the focuses is placed on the midway of the element 3.

Under the normal conditions the element starts arcing at the midway point of the element the shock wave generated there reflects on the wall of spheroidal concaves 5 and converges at the focuses 6-a and 6-b.

The arc extinction mentioned above is subsequently happened by the focused shock wave.

The arrows show the path route of the shock wave. This action is caused on both spheroids.

This type of body construction is more applicable to the short fuse, especially classified as micro fuse, the longitudinal dimension of which is not so long for the diameter.

### DESCRIPTION OF THE SECOND PREFERRED EMBODIMENT

In a fuse (FIG. 7) which has relatively longer body comparing to the cross section, the shock wave generated by spot explosion of the arc becomes flat shock wave while it is passing through the long insulation body. (Reference 3)

The paraboloidal reflection wall is adopted on both end of the body so as to converge this flat shock wave. In this preferred embodiment the terminals 2 has internal concave wall to converge the shock wave at the focus point 6-a and 6-b.

In this embodiment the fuse is filled with filler material like granular quartz 7.

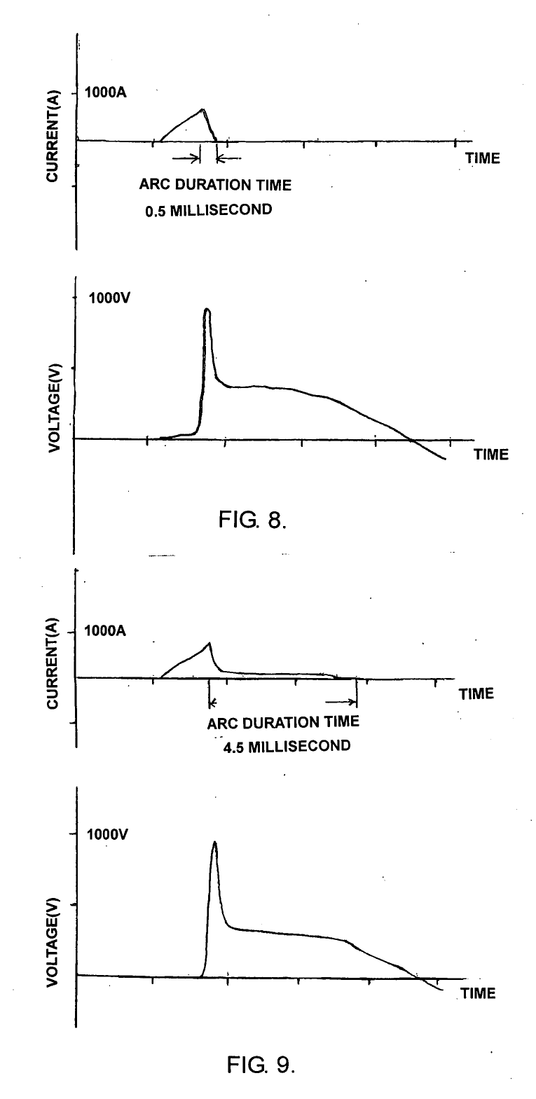

Waveforms of second embodiment are shown in FIG. 8 comparing to that of the conventional sand filled fuse. (FIG. 9)

The arcing time in the current waveform is highly shortened until 0.5 millisecond. This arc suppression decreases heat generation of the arc and subsequently the insulation body and terminal caps are kept from any damage.

Table 1 shows the summery of breaking capacity test on the embodiment 2. For the case that any explosion of the body or damage of terminal is not perceived, table counts successful interruption.

This table has confirmed the utilization of shock wave in the breaking test.

TABLE 1

| | | | Succesfully | Percentage of |
|---|---|---|---|---|
| | | Arc duration | interrupted | Successfully |
| | Tested | time | number of | interrupted |
| Types of fuselink | numbers | (millisecond) | fuselink | fuselink |
| Conventional cartridge | 30 pieces | Av. 4.5 | 11 pieces | 37% |
| fuselink filled with sand | | | | |
| Invented cartridge fuselink | 30 pieces | Av. 1.1 | 30 pieces | 100% |
| filled with sand | | | | |
| as the second preferred | | | | |
| embodiment | | | | |

### DESCRIPTION OF THE THIRD PREFERRED EMBODIMENT

A fuselink of current rating 30 A is made with the same configuration and same material to embodiment 2.

This fuse was examined by a breaking capacity test of 500V-1,000 A DC, where was no zero cross point.

And as the result, tranquil breaking was accomplished because of utilization of the shock wave, while conventional fuse was broken.

1 Method of avoiding arc prolongation while interrupting the current, using the shock wave generated by the arc discharge, including the internal concave wall of the body, comprising paraboloidal concave wall, spheroidal concave wall, hyperboloidal concave wall or other concave walls and polyhedral walls which converge and reflect the shock wave onto the prolonged arc point.

2 Method of forming a cartridge current fuse, comprising conductors, fusible element which is electrically connected to conductors, and nonconductive body wherein inner wall of the conductors or/and fuse body forms the concave which converge and reflect the shock wave generated by the arc discharge to make the focus onto the prolonged arc.
